(19) United States
(12) Patent Application Publication
(10) Pub. No.: US 2025/0239942 A1
(43) Pub. Date: Jul. 24, 2025

(54) POWER SUPPLY SYSTEM, ARTICLE OF PERSONAL PROTECTIVE EQUIPMENT, AND METHOD OF IMPROVING POWER EFFICIENCY OF POWER SUPPLY SYSTEM

(71) Applicant: 3M INNOVATIVE PROPERTIES COMPANY, St. Paul, MN (US)

(72) Inventors: DARIN K. Thompson, Huntersville, NC (US); William B. Howell, Pineville, NC (US); David A. Amero, Calgary (CA); Ivan M. Delamer, Calgary (CA); Pablo Gonzalez-Campos, Main Olds (CA); Yash M. Kavi, Calgary (CA)

(21) Appl. No.: 18/838,319

(22) PCT Filed: Feb. 3, 2023
(86) PCT No.: PCT/IB2023/050985

§ 371 Date: Aug. 14, 2024

Related U.S. Application Data
(60) Provisional application No. 63/268,107, filed on Feb. 16, 2022.

(51) Int. Cl. H02M 3/335; H02M 1/00; H02M 1/08; H02M 3/26

(52) U.S. Cl. CPC H02M 3/33571; H02M 1/0009; H02M 1/007; H02M 1/08; H02M 3/26

(57) ABSTRACT

A power supply system is provided including a transformer, a plurality of switches, a rectifier circuit, and a controller. The transformer includes at least one primary winding and at least one secondary winding. The plurality of switches is configured to receive an input direct current (DC) power and provide a transformer input power to the primary winding. The secondary winding is configured to provide a transformer output power based on the transformer input power. The rectifier circuit is configured to receive the transformer output power and provide an output DC power to one or more external loads. The output DC power is a product of a total load current and an output voltage. The controller is configured to determine the total load current required for the external loads and control the plurality of switches to provide a switching frequency based on the total load current required for the external loads.

### TECHNICAL FIELD

The present disclosure relates to a power supply system and a method of improving a power efficiency of the power supply system. The present disclosure further relates to an article of personal protective equipment (PPE) including the power supply system.

### BACKGROUND

Articles of personal protective equipment (PPE) generally include a power supply. The power supply may include a transformer and a transformer driver for operating the transformer. The transformer may work well at low and medium loads but may not work well at higher loads. The articles of PPE may be configured to include different electronic devices that may have different electric power requirements. Therefore, in some cases, the transformer of the power supply may not operate at optimal power efficiencies with some of the electronic devices.

### SUMMARY

In a first aspect, the present disclosure provides a power supply system. The power supply system includes a transformer including at least one primary winding and at least one secondary winding. The power supply system further includes a plurality of switches. The plurality of switches is configured to receive an input direct current (DC) power and provide a transformer input power to the at least one primary winding based on the input DC power. The input DC power is a product of an input current and an input voltage. The at least one secondary winding is configured to provide a transformer output power based on the transformer input power. The power supply system further includes a rectifier circuit configured to receive the transformer output power and provide an output DC power to one or more external loads electrically coupled to the power supply system based on the transformer output power. The output DC power is a product of a total load current and an output voltage. Furthermore, the power supply system includes a controller communicably coupled to the plurality of switches. The controller is configured to determine the total load current required for the one or more external loads. The controller is further configured to control the plurality of switches to provide a switching frequency based on the total load current required for the one or more external loads.

In a second aspect, the present disclosure provides an article of personal protective equipment (PPE) including the power supply system of the first aspect.

In a third aspect, the present disclosure provides a method of improving a power efficiency of a power supply system. The method includes providing a transformer including at least one primary winding and at least one secondary winding. The method further includes receiving, by a plurality of switches, an input DC power. The input DC power is a product of an input current and an input voltage. The method further includes providing, via the plurality of switches, a transformer input power to the at least one primary winding based on the input DC power. The method further includes providing, via the at least one secondary winding, a transformer output power based on the transformer input power to a rectifier circuit. The method further includes providing, via the rectifier circuit, an output DC power to one or more external loads electrically coupled to the power supply system based on the transformer output power. The output DC power is a product of a total load current and an output voltage. The method further includes determining, via a controller, the total load current required for the one or more external loads. The method further includes controlling, via the controller, the plurality of switches to provide a switching frequency based on the determined total load current required for the one or more external loads.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

Exemplary embodiments disclosed herein is more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labelled with the same number.

FIG. 1 illustrates a schematic block diagram of an article of personal protective equipment (PPE), according to an embodiment of the present disclosure;

FIG. 2 illustrates a detailed schematic diagram of a power supply system of an article of PPE, according to an embodiment of the present disclosure;

FIG. 3 illustrates a plot depicting a variation in a switching frequency for different total load currents required for one or more external loads of the power supply system, according to an embodiment of the present disclosure;

FIG. 4 illustrates a plot depicting a variation in the switching frequency for different total load currents required for the one or more external loads of the power supply system, according to an embodiment of the present disclosure;

FIG. 5 illustrates a flowchart depicting a method of improving a power efficiency of the power supply system, according to an embodiment of the present disclosure;

FIG. 6 illustrates a plot depicting a variation of the power efficiency of the power supply system with an input voltage for different switching frequencies, when a total load current is about 0.2 A, according to an embodiment of the present disclosure;

FIG. 7 illustrates a plot depicting a variation of the power efficiency of the power supply system with the input voltage for different switching frequencies, when the total load current is about 0.4 A, according to an embodiment of the present disclosure; and

FIG. 8 illustrates a plot depicting a variation of the power efficiency of the power supply system with the input voltage for different switching frequencies, when the total load current is about 0.6 A, according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and is made without departing from the scope or spirit of the present disclosure. The following detailed description, therefore, is not to be taken in a limiting sense.

In the following disclosure, the following definitions are adopted.

As used herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, “at least one of A and B” should be understood to mean “only A, only B, or both A and B”.

As used herein, the term “an article of personal protective equipment (PPE)” may include any type of equipment or clothing that may be used to protect a user from hazardous or potentially hazardous environmental conditions. In some examples, one or more individuals, such as the users, may utilize the article of PPE while engaging in tasks or activities within the hazardous or potentially hazardous environment. Examples of the articles of PPE may include, but are not limited to, hearing protection (including ear plugs and ear muffs), respiratory protection equipment (including disposable respirators, reusable respirators, powered air purifying respirators, self-contained breathing apparatus and supplied air respirators), facemasks, oxygen tanks, air bottles, protective eyewear, such as visors, goggles, filters or shields (any of which may include augmented reality functionality), protective headwear, such as hard hats, hoods or helmets, protective shoes, protective gloves, other protective clothing, such as coveralls, aprons, coat, vest, suits, boots and/or gloves, protective articles, such as sensors, safety tools, detectors, global positioning devices, mining cap lamps, fall protection harnesses, exoskeletons, self-retracting lifelines, heating and cooling systems, gas detectors, and any other suitable gear configured to protect the users from injury. The articles of PPE may also include any other type of clothing or device/equipment that may be worn or used by the users to protect against extreme noise levels, extreme temperatures, fire, reduced oxygen levels, explosions, reduced atmospheric pressure, radioactive, and/or biologically harmful materials.

As used herein, the term “electrically coupled” refers to direct coupling between components and/or indirect coupling between components via one or more intervening electric components, such that an electric signal can be passed between the two components. As an example of indirect coupling, two components can be referred to as being electrically coupled, even though they may have an intervening electric component between them which still allows an electric signal to pass from one component to the other component. Such intervening components may comprise, but are not limited to, wires, traces on a circuit board, and/or another electrically conductive medium/component.

As used herein, the term “communicably coupled to” refers to direct coupling between components and/or indirect coupling between components via one or more intervening components. Such components and intervening components may comprise, but are not limited to, junctions, communication paths, components, circuit elements, circuits, functional blocks, and/or devices. As an example of indirect coupling, a signal conveyed from a first component to a second component may be modified by one or more intervening components by modifying the form, nature, or format of information in a signal, while one or more elements of the information in the signal are nevertheless conveyed in a manner than can be recognized by the second component.

As used herein, the term “signal,” includes, but is not limited to, one or more electrical signals, optical signals, electromagnetic signals, analog and/or digital signals, one or more computer instructions, a bit and/or bit stream, or the like.

Articles of personal protective equipment (PPE) may be configured to include different electronic devices that may have different electrical power requirements. Generally, the article of PPE includes a power supply that provides electric power to the different electronic devices. The power supply may include a battery, a transformer, and a transformer driver that may control and operate the transformer. In some cases, the transformer may work optimally at low and medium loads but may not work optimally at higher loads. Specifically, in some cases, the transformer of the power supply may not operate at optimal power efficiencies with some of the different electronic devices having higher electric power requirements. This may further negatively affect a battery life of the battery.

The present disclosure provides a power supply system. The present disclosure further provides a method of improving the power efficiency of the power supply system.

The power supply system includes a transformer including at least one primary winding and at least one secondary winding. The power supply system further includes a plurality of switches configured to receive an input direct current (DC) power and provide a transformer input power to the at least one primary winding based on the input DC power. The input DC power is a product of an input current and an input voltage. The at least one secondary winding is configured to provide a transformer output power based on the transformer input power. The power supply system further includes a rectifier circuit configured to receive the transformer output power and provide an output DC power to one or more external loads electrically coupled to the power supply system based on the transformer output power. The output DC power is a product of a total load current and an output voltage. The power supply system further includes a controller communicably coupled to the plurality of switches. The controller is configured to determine the total load current required for the one or more external loads. The controller is further configured to control the plurality of switches to provide a switching frequency based on the total load current required for the one or more external loads.

Since, the controller of the power supply system of the present disclosure determines the total load current required for the one or more external loads and controls the plurality of switches to provide the switching frequency to the transformer input power based on the total load current required for the one or more external loads, a power efficiency of the power supply system may be improved. As a result, the power supply system may cater to the different electrical power requirements of the one or more external loads without significant wastage of electrical power.

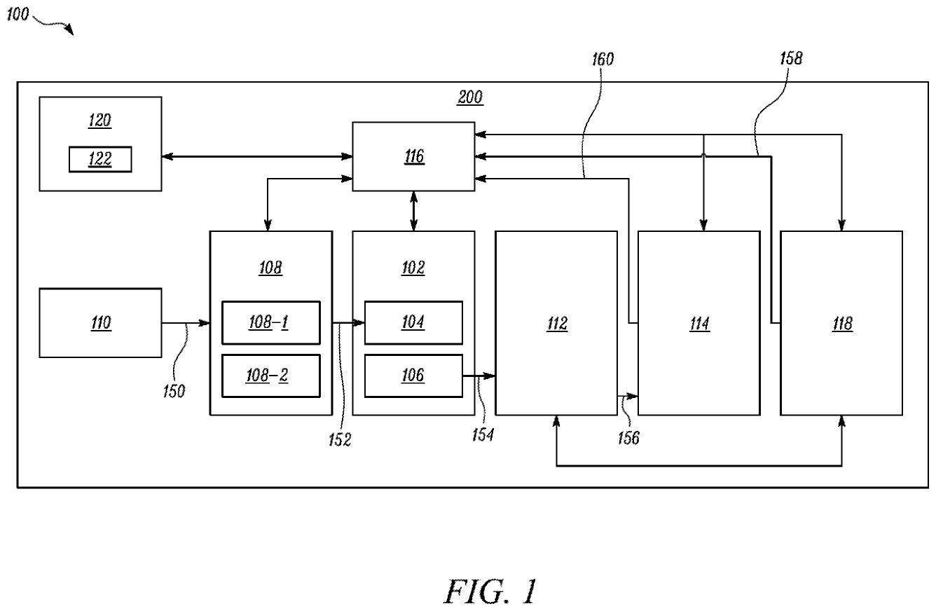

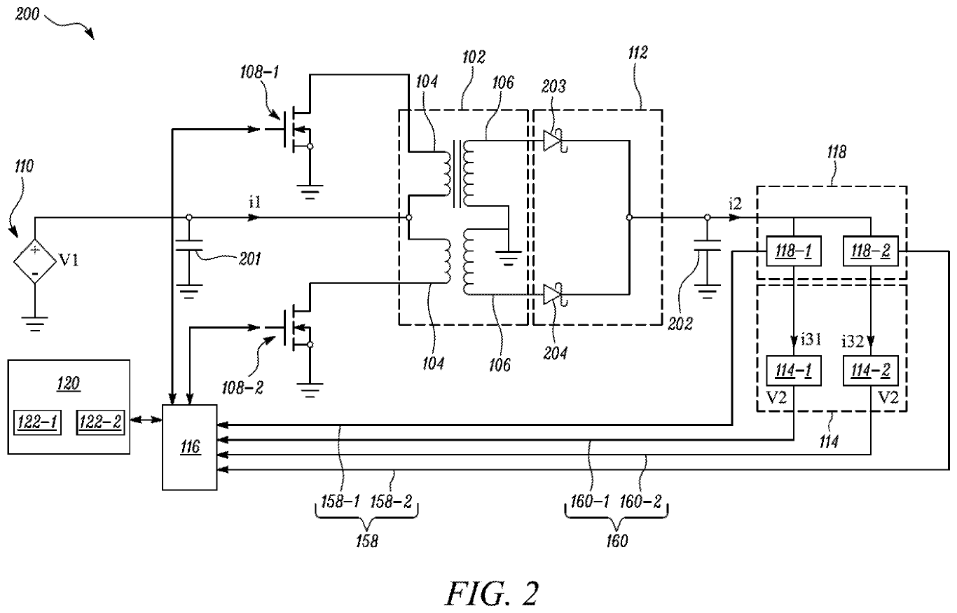

Referring to figures, FIG. 1 illustrates a schematic block diagram of an article of personal protective equipment (PPE) 100, according to an embodiment of the present disclosure. The article of PPE 100 includes a power supply system 200. FIG. 2 illustrates a detailed schematic diagram of the power supply system 200, according to an embodiment of the present disclosure.

Referring now to FIGS. 1 and 2, the power supply system 200 includes a transformer 102. The transformer 102 includes at least one primary winding 104 and at least one secondary winding 106. In the illustrated embodiment of FIG. 2, the at least one primary winding 104 includes two primary windings 104 and the at least one secondary winding 106 includes two secondary windings 106.

The power supply system 200 further includes a plurality of switches 108. The plurality of switches 108 is configured to receive an input direct current (DC) power 150. In the illustrated embodiment of FIG. 2, the plurality of switches 108 includes first and second switches 108-1, 108-2. In some embodiments, each of the plurality of switches 108 may include a metal-oxide-semiconductor field-effect transistor (MOSFET), an insulated gate bipolar transistor (IGBT), a gate turn-off thyristor (GTO), or a bipolar junction transistor (BJT). However, in some other embodiments, each of the plurality of switches 108 may include any other switch, as per application requirements.

The plurality of switches 108 is further configured to provide a transformer input power 152 to the at least one primary winding 104 based on the input DC power 150. The input DC power 150 is a product of an input current i1 and an input voltage V1. The transformer input power 152 may be an alternating current (AC) power.

In some embodiments, the power supply system 200 further includes a power source 110 configured to provide the input DC power 150 to the plurality of switches 108. In some embodiments, the power source 110 may include a battery, a fuel cell, an ultracapacitor, and/or any other suitable voltage source. In some embodiments, the battery may be any type of battery, such as a lead acid battery, a lithium-ion battery, a nickel-metal battery, and/or any other rechargeable battery. In some embodiments, the ultracapacitor may include a supercapacitor, an electrochemical double layer capacitor, and/or any other electrochemical capacitor with high energy density. In some embodiments, the power source 110 is a variable voltage source.

In some embodiments, the transformer input power 152 provided to the at least one primary winding 104 of the transformer 102 may cause a primary electrical current to flow in the at least one primary winding 104. As a result, a magnetic field may be generated by the primary electrical current flowing in the at least one primary winding 104. The magnetic field may induce a secondary electrical current to flow in the at least one secondary winding 106 of the transformer 102. In other words, the transformer input power 152 provided to the at least one primary winding 104 may induce a transformer output power 154 in the at least one secondary winding 106. The transformer output power 154 may be an AC power.

In some embodiments, for a given configuration of the at least one primary winding 104 and the at least one secondary winding 106 (e.g., a total number of the at least one primary and secondary windings 104, 106), a magnitude of the transformer output power 154 is based on a magnitude of the transformer input power 152. In some cases, a magnitude of a secondary voltage of the transformer output power 154 may be greater than a magnitude of a primary voltage of the transformer input power 152. In such cases, the transformer 102 may be a step-up transformer. In some other cases, the magnitude of the secondary voltage of the transformer output power 154 may be less than the magnitude of the primary voltage of the transformer input power 152. In such cases, the transformer 102 may be a step-down transformer. Therefore, the at least one secondary winding 106 is configured to provide the transformer output power 154 based on the transformer input power 152.

The power supply system 200 further includes a rectifier circuit 112. The rectifier circuit 112 is configured to receive the transformer output power 154 and provide an output DC power 156 to one or more external loads 114 electrically coupled to the power supply system 200 based on the transformer output power 154. The output DC power 156 is a product of a total load current i2 and an output voltage V2. In some embodiments, the rectifier circuit 112 may include components, such as diodes, thyristors, Zener diodes, etc. For example, in the illustrated embodiment of FIG. 2, the rectifier circuit 112 includes Zener diodes 203, 204. The rectifier circuit 112 is configured to convert the transformer output power 154 to the output DC power 156 that may be utilized by the one or more external loads 114.

In some examples, the one or more external loads 114 may include one or more accessories that may be used with the article of PPE 100. The one or more accessories may be electrically coupled to the power supply system 200 through an interface, such as a universal expansion port (UEP). The one or more accessories may include one or more of bone conduction headphones, communication systems, heads-up displays (HUD), and so forth. In the illustrated embodiment of FIG. 2, the one or more external loads 114 includes first and second external loads 114-1, 114-2.

In some embodiments, the total load current i2 may be a sum of currents that are required for the one or more external loads 114. For example, the first and second external loads 114-1, 114-2 may require respective first and second load currents i31, i32. Therefore, the total load current i2 may be a sum of the first and second load currents i31, i32, i.e., i2=i31+i32.

The power supply system 200 further includes a controller 116 communicably coupled to the plurality of switches 108. The controller 116 may include a processor (not shown) and a memory (not shown) storing executable instructions. The processor may execute the instructions stored in the memory to implement a method or an algorithm. The controller 116 is configured to determine the total load current i2 required for the one or more external loads 114.

In some embodiments, the power supply system 200 further includes one or more current sensors 118 communicably coupled to the controller 116. In some embodiments, the one or more current sensors 118 are configured to measure the respective load currents required for the one or more external loads 114. In some embodiments, the one or more current sensors 118 may generate signals 158 indicative of the respective load currents required for the one or more external loads 114. In the illustrated embodiment of FIG. 2, the one or more current sensors 118 include first and second currents sensors 118-1, 118-2 corresponding to the first and second external loads 114-1, 114-2. The first and second current sensors 118-1, 118-2 are configured to generate signals 158-1, 158-2, respectively. The signals 158-1, 158-2 are indicative of the first and second load currents i31, i32, respectively.

In some embodiments, the controller 116 is configured to receive the respective signals 158 from the one or more current sensors 118 indicative of the respective load currents required for the one or more external loads 114. In some embodiments, the controller 116 is configured to determine the total load current i2 as the sum of the respective load currents required for the one or more external loads 114 based on the respective signals 158. For example, the controller 116 may receive the respective signals 158-1, 158-2 from the first and second current sensors 118-1, 118-2 indicative of the respective first and second load currents i31, i32 required for the first and second external loads 114-1, 114-2. Further, the controller 116 may determine the total load current i2 as the sum of the first and second load currents i31, i32 required for the first and second external loads 114-1, 114-2 based on the respective signals 158-1, 158-2.

In some embodiments, the power supply system 200 may include one or more current sensors (not shown) electrically disposed between the power source 110 and the at least one primary winding 104. The one or more current sensors electrically disposed between the power source 110 and the at least one primary winding 104 may be substantially similar to the one or more current sensors 118. The one or more sensors are communicably coupled to the controller 116. In some embodiments, the one or more sensors may be configured to measure the input current i1 of the input DC power 150. The one or more sensors are configured to generate respective signals (not shown) indicative of the input current i1. In some embodiments, the controller 116 is further configured to receive the respective signals from the one or more current sensors indicative of the input current i1. In some embodiments, the controller 116 is configured to determine the total load current i2 as a product of the input current i1 and a transformer turn ratio n of the transformer 102, i.e., i2=n*i1. The transformer turn ratio n may be determined using a number n1 of at least one primary winding 104 and a number n2 of at least one secondary winding 106 using the relation, n=n1/n2.

In some embodiments, the controller 116 is communicably coupled to the one or more external loads 114. In some embodiments, the one or more external loads 114 may be configured to generate respective signals 160 indicative of the respective load currents required for the one or more external loads 114. For example, in the illustrated embodiment of FIG. 2, the first and second external loads 114-1, 114-2 are configured to generate respective signals 160-1, 160-2 indicative of the first and second load currents i31, i32 required for the first and second external loads 114-1, 114-2, respectively. In some embodiments, the controller 116 is configured to receive the respective signals 160 from the one or more external loads 114 indicative of the respective load currents required for the one or more external loads 114. In some embodiments, the controller 116 is further configured to determine the total load current i2 as a sum of the respective load currents required for the one or more external loads 114 based on the respective signals 160. For example, in the illustrated embodiment of FIG. 2, the controller 116 is configured to receive the respective signals 160-1, 160-2 from the first and second external loads 114-1, 114-2 indicative of the first and second load currents i31, i32 required for the first and second external loads 114-1, 114-2, respectively. In some embodiments, the controller 116 is further configured to determine the total load current i2 as a sum of the first and second load currents i31, i32 required for the first and second external loads 114-1, 114-2 based on the respective signals 160-1, 160-2.

In some embodiments, the controller 116 is configured to determine a total number of the one or more external loads 114 electrically coupled to the power supply system 200. In some embodiments, the controller 116 is configured to determine the total load current i2 required for the one or more external loads 114 based on the number of the one or more external loads 114 electrically coupled to the power supply system 200. For example, in the illustrated embodiment of FIG. 2, the controller 116 may determine a total number of the one or more external loads 114 electrically coupled to the power supply system 200 is two (i.e., the first and second external loads 114-1, 114-2). Further, the controller 116 may determine the total load current i2 required for two of the one or more external loads 114.

In some embodiments, the power supply system 200 further includes a memory 120 communicably coupled to the controller 116. In some embodiments, the memory 120 is configured to store respective one or more parameters 122 associated with the one or more external loads 114. In some embodiments, the respective one or more parameters 122 include respective data of load currents required for the one or more external loads 114. In some embodiments, the controller 116 is further configured to retrieve the respective data of load currents from the memory 120 and determine the total load current i2 as a sum of the respective load currents required for the one or more external loads 114 based on the respective one or more parameters 122. For example, in the illustrated embodiment of FIG. 2, the memory 120 stores first and second parameters 122-1, 122-2 associated with the first and second external loads 114-1, 114-2. In some embodiments, the first and second parameters 122-1, 122-2 include the respective data of first and second load currents i31, i32 required for the first and second external loads 114-1, 114-2, respectively. Further, the controller 116 may retrieve the data of respective first and second load currents i31, i32 from the memory 120 and determine the total load current i2 as a sum of the respective first and second load currents i31, i32 required for the first and second external loads 114-1, 114-2 based on the first and second parameters 122-1, 122-2.

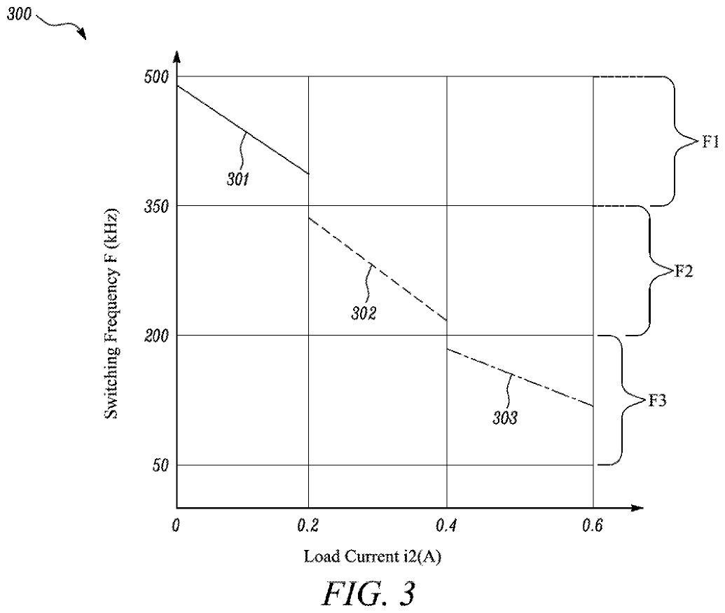

The controller 116 is further configured to control the plurality of switches 108 to provide a switching frequency F (shown in FIG. 3) based on the total load current i2 required for the one or more external loads 114.

In some embodiments, the power supply system 200 may further include capacitors 201, 202. The capacitor 201 may be electrically disposed between the power source 110 and the at least one primary winding 104. The capacitor 202 may be electrically disposed between the one or more external loads 114 and the at least one secondary winding 106. The capacitors 201, 202 may be charged and/or discharged at high speeds. As a result, the capacitors 201, 202 may level and/or smooth voltage and/or current ripples that may arise during operation of the power supply system 200.

FIG. 3 illustrates a plot 300 depicting a variation in the switching frequency F for different total load currents i2 (shown in FIG. 1) required for the one or more external loads 114 (shown in FIG. 1), according to an embodiment of the present disclosure. The total load current i2 is depicted in Amperes (A) in the abscissa and the switching frequency F is depicted in kilohertz (kHz) in the ordinate. Referring to FIGS. 1 and 3, as discussed above, the controller 116 is configured to control the plurality of switches 108 to provide the switching frequency F based on the total load current i2 required for the one or more external loads 114.

The plot 300 includes curves 301, 302, 303 depicting respective variations in the switching frequency F for different total load currents i2 required for the one or more external loads 114.

Referring to the curve 301, in some embodiments, the controller 116 is further configured to control the plurality of switches 108 to provide the switching frequency F in a first frequency range F1 when the total load current i2 required for the one or more external loads 114 is greater than about 0 A and less than or equal to about 0.2 A. In some embodiments, the first frequency range F1 is from greater than about 350 kHz to less than or equal to about 500 kHz. In some embodiments, the controller 116 is further configured to control the plurality of switches 108 to provide the switching frequency F in the first frequency range F1 when the total load current i2 required for the one or more external loads 114 is greater than about 0.02 A and less than or equal to about 0.2 A. In the illustrated embodiment of FIG. 3, the curve 301 lies in the first frequency range F1 and has the switching frequency F from about 390 kHz to about 480 kHz.

Referring to the curve 302, in some embodiments, the controller 116 is further configured to control the plurality of switches 108 to provide the switching frequency F in a second frequency range F2 non-overlapping with the first frequency range F1 when the total load current i2 required for the one or more external loads 114 is greater than about 0.2 A and less than or equal to about 0.4 A. In some embodiments, the second frequency range F2 is from greater than about 200 kHz to less than or equal to about 350 kHz. In the illustrated embodiment of FIG. 3, the curve 302 lies in the second frequency range F2 and has the switching frequency F from about 230 kHz to about 330 kHz.

Referring to the curve 303, in some embodiments, the controller 116 is further configured to control the plurality of switches 108 to provide the switching frequency F in a third frequency range F3 non-overlapping with each of the first and second frequency ranges F1, F2 when the total load current i2 required for the one or more external loads 114 is greater than about 0.4 A and less than or equal to about 0.6 A. In some embodiments, the third frequency range F3 is from greater than or equal to about 50 kHz to less than or equal to about 200 kHz. In the illustrated embodiment of FIG. 3, the curve 303 lies in the third frequency range F3 and has the switching frequency F from about 125 kHz to about 180 kHz.

In some embodiments, the controller 116 controls the switching frequency F, such that a power efficiency P of the power supply system 200 is greater than about 80% for the input voltage V1 greater than about 2 Volts (V) and less than or equal to about 5 V. In some embodiments, the power efficiency P is a percentage ratio of the output DC power 156 to the input DC power 150, i.e., P=((Output DC Power/Input DC Power)×100).

Therefore, the power efficiency P of the power supply system 200 may be improved by controlling the plurality of switches 108 to provide the switching frequency F based on the total load current i2 required for the one or more external loads 114. As a result, the power supply system 200 may cater to the different electrical power requirements of the one or more external loads 114 without significant wastage of electrical power. Further, this may also improve a life of the power source 110.

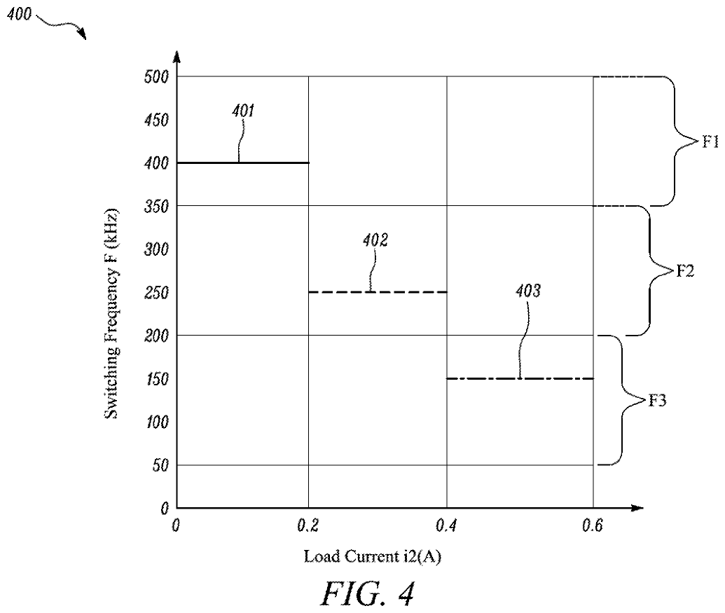

FIG. 4 illustrates a plot 400 depicting a variation in the switching frequency F for different total load currents i2 (shown in FIG. 1) required for the one or more external loads 114 (shown in FIG. 1), according to an embodiment of the present disclosure.

The plot 400 includes curves 401, 402, 403 depicting respective variations in the switching frequency F for different total load currents i2 required for the one or more external loads 114.

Referring to FIGS. 1 and 4, and referring to the curve 401, in some embodiments, the controller 116 is further configured to control the plurality of switches 108 to provide the switching frequency F of about 400 kHz when the total load current i2 required for the one or more external loads 114 is greater than about 0 A and less than or equal to about 0.2 A. Therefore, the curve 401 lies in the first frequency range F1 and has the switching frequency F of about 400 kHz.

Referring to the curve 402, in some embodiments, the controller 116 is further configured to control the plurality of switches 108 to provide the switching frequency F of about 250 kHz when the total load current i2 required for the one or more external loads 114 is greater than about 0.2 A and less than or equal to about 0.4 A. Therefore, the curve 402 lies in the second frequency range F2 and has the switching frequency F of about 250 kHz.

Referring to the curve 403, in some embodiments, the controller 116 is further configured to control the plurality of switches 108 to provide the switching frequency F of about 150 kHz when the total load current i2 required for the one or more external loads 114 is greater than about 0.4 A and less than or equal to about 0.6 A. Therefore, the curve 403 lies in the third frequency range F3 and has the switching frequency F of about 150 kHz.

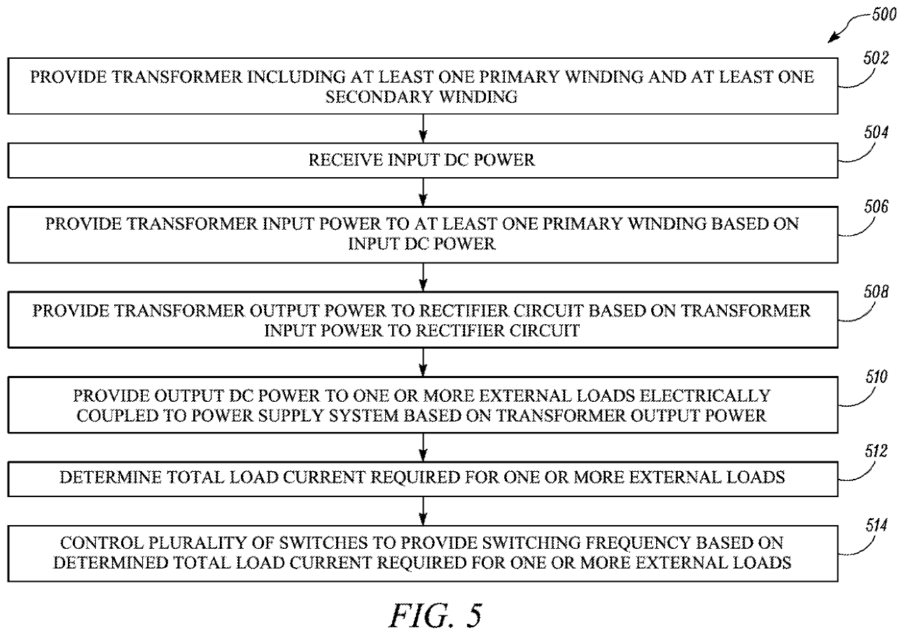

FIG. 5 illustrates a flowchart depicting a method 500 of improving the power efficiency P of the power supply system 200, according to an embodiment of the present disclosure. The method 500 will be further described with reference to FIGS. 1 to 4.

At step 502, the method 500 includes providing the transformer 102 including the at least one primary winding 104 and the at least one secondary winding 106.

At step 504, the method 500 includes receiving, by the plurality of switches 108, the input DC power 150. In some embodiments, the method 500 includes providing the power source 110 configured to provide the input DC power 150 to the plurality of switches 108.

At step 506, the method 500 further includes providing, via the plurality of switches 108, the transformer input power 152 to the at least one primary winding 104 based on the input DC power 150.

At step 508, the method 500 further includes providing, via the at least one secondary winding 106, the transformer output power 154 based on the transformer input power 152 to the rectifier circuit 112.

At step 510, the method 500 further includes providing, via the rectifier circuit 112, the output DC power 156 to the one or more external loads 114 electrically coupled to the power supply system 200 based on the transformer output power 154.

At step 512, the method 500 further includes determining, via the controller 116, the total load current i2 required for the one or more external loads 114.

In some embodiments, determining the total load current i2 required for the one or more external loads 114 further includes providing the one or more current sensors 118. In some embodiments, determining the total load current i2 required for the one or more external loads 114 further includes receiving, via the controller 116, the respective signals 158 from the one or more current sensors 118 indicative of the respective load currents required for the one or more external loads 114. In some embodiments, determining the total load current i2 required for the one or more external loads 114 further includes determining, via the controller 116, the total load current i2 as the sum of the respective load currents required for the one or more external loads 114 based on the respective signals 158.

In some embodiments, determining the total load current i2 required for the one or more external loads 114 further includes providing the one or more sensors electrically disposed between the power source 110 and the at least one primary winding 104. In some embodiments, determining the total load current i2 required for the one or more external loads 114 further includes receiving, via the controller 116, the respective signals from the one or more current sensors indicative of the input current i1. In some embodiments, determining the total load current i2 required for the one or more external loads 114 further includes determining, via the controller 116, the total load current i2 as the product of the input current based on the respective signals and the transformer turn ratio n of the transformer 102.

In some embodiments, determining the total load current i2 required for the one or more external loads 114 further includes receiving, via the controller 116, the respective signals 160 from the one or more external loads 114 indicative of the respective load currents required for the one or more external loads 114. In some embodiments, determining the total load current i2 required for the one or more external loads 114 further includes determining, via the controller 116, the total load current i2 as a sum of the respective load currents required for the one or more external loads 114 based on the respective signals 160.

In some embodiments, determining the total load current i2 required for the one or more external loads 114 further includes determining, via the controller 116, the total number of the one or more external loads 114 electrically coupled to the power supply system 200. In some embodiments, determining the total load current i2 required for the one or more external loads 114 further includes determining, via the controller 116, the total load current i2 required for the one or more external loads 114 based on the number of the one or more external loads 114 electrically coupled to the power supply system 200.

In some embodiments, determining the total load current i2 required for the one or more external loads 114 further includes retrieving, from the memory 120, the respective one or more parameters 122 associated with the one or more external loads 114. In some embodiments, determining the total load current i2 required for the one or more external loads 114 further includes determining, via the controller 116, the total load current i2 as a sum of the respective load currents required for the one or more external loads 114 based on the respective one or more parameters 122.

At step 514, the method 500 further includes controlling, via the controller 116, the plurality of switches 108 to provide the switching frequency F based on the determined total load current i2 required for the one or more external loads 114.

In some embodiments, controlling the plurality of switches 108 further includes controlling the plurality of switches 108 to provide the switching frequency F in the first frequency range F1 when the total load current i2 required for the one or more external loads 114 is greater than about 0 A and less than or equal to about 0.2 A. In some embodiments, controlling the plurality of switches 108 further includes controlling the plurality of switches 108 to provide the switching frequency F in the first frequency range F1 when the total load current i2 required for the one or more external loads 114 is greater than about 0.02 A and less than or equal to about 0.2 A. In some embodiments, controlling the plurality of switches 108 further includes controlling the plurality of switches 108 to provide the switching frequency F of about 400 kHz when the total load current i2 required for the one or more external loads 114 is greater than about 0 A and less than or equal to about 0.2 A.

In some embodiments, controlling the plurality of switches 108 further includes controlling the plurality of switches 108 to provide the switching frequency F in the second frequency range F2 non-overlapping with the first frequency range F1 when the total load current i2 required for the one or more external loads 114 is greater than about 0.2 A and less than or equal to about 0.4 A. In some embodiments, controlling the plurality of switches 108 further includes controlling the plurality of switches 108 to provide the switching frequency F of about 250 kHz when the total load current i2 required for the one or more external loads 114 is greater than about 0.2 A and less than or equal to about 0.4 A.

In some embodiments, controlling the plurality of switches 108 further includes controlling the plurality of switches 108 to provide the switching frequency F in the third frequency range F3 non-overlapping with each of the first and second frequency ranges F1, F2 when the total load current i2 required for the one or more external loads 114 is greater than about 0.4 A and less than or equal to about 0.6 A. In some embodiments, controlling the plurality of switches 108 further includes controlling the plurality of switches 108 to provide the switching frequency F of about 150 kHz when the total load current i2 required for the one or more external loads 114 is greater than about 0.4 A and less than or equal to about 0.6 A.

In some embodiments, controlling the plurality of switches 108 further includes controlling the switching frequency F, such that the power efficiency P of the power supply system 200 is greater than about 80% for the input voltage V1 greater than or equal to about 2 Volts and less than or equal to about 5 Volts.

### Examples and Data

Various tests were conducted using an exemplary power supply system, according to an embodiment of the present disclosure. The exemplary power supply system was substantially similar to the power supply system 200 (shown in FIG. 1). The tests were set up to evaluate an optimal switching frequency (the switching frequency F) of the plurality of switches 108 for a specified load current (the total load current i2). The controller 116 was configured to control the plurality of switches 108, such that the switching frequency F was varied from about 100 kHz to about 500 kHz in increments of about 50 kHz for each of the total load current i2. For each value of the switching frequency F, the input voltage V1 was incremented from about 3 V to about 4.2 V in steps of about 0.048 V. For each value of the switching frequency F, the total load current i2, and for each value of the input voltage V1, the power efficiency P of the power supply system 200 was determined.

For different values of the total load current i2, the process of determining the power efficiency P of the power supply system 200 for each value of the switching frequency F for each value of the input voltage V1 was carried out, and the results were plotted.

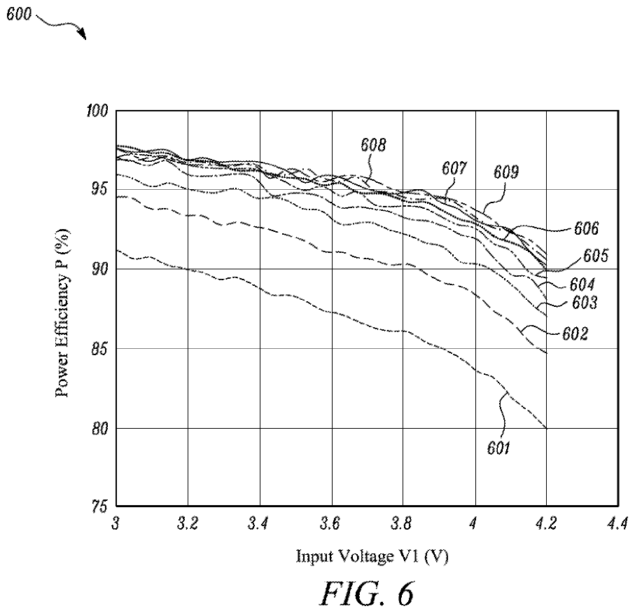

FIG. 6 illustrates a plot 600 depicting a variation of the power efficiency P of the power supply system 200 (shown in FIG. 1) with the input voltage V1 for different switching frequencies F when the total load current i2 was about 0.2 A. The input voltage V1 is depicted in Volts (V) in the abscissa and the power efficiency P of the power supply system 200 is depicted as a power efficiency percentage in the ordinate.

Referring now to FIGS. 1 and 6, the plot 600 illustrates a curve 601 depicting the variation of the power efficiency P of the power supply system 200 with the input voltage V1 for the switching frequency F of 100 kHz, a curve 602 depicting the variation of the power efficiency P of the power supply system 200 with the input voltage V1 for the switching frequency F of 150 kHz, a curve 603 depicting the variation of the power efficiency P of the power supply system 200 with the input voltage V1 for the switching frequency F of 200 kHz, a curve 604 depicting the variation of the power efficiency P of the power supply system 200 with the input voltage V1 for the switching frequency F of 250 kHz, a curve 605 depicting the variation of the power efficiency P of the power supply system 200 with the input voltage V1 for the switching frequency F of 300 kHz, a curve 606 depicting the variation of the power efficiency P of the power supply system 200 with the input voltage V1 for the switching frequency F of 350 kHz, a curve 607 depicting the variation of the power efficiency P of the power supply system 200 with the input voltage V1 for the switching frequency F of 400 kHz, a curve 608 depicting the variation of the power efficiency P of the power supply system 200 with the input voltage V1 for the switching frequency F of 450 kHz, and a curve 609 depicting the variation of the power efficiency P of the power supply system 200 with the input voltage V1 for the switching frequency F of 500 kHz.

As is apparent from the curves 601 to 609, for the total load current i2 of about 0.2 A, the optimal switching frequency F at which the power efficiency P of the power supply system 200 was optimal was about 400 kHz (depicted by the curve 607).

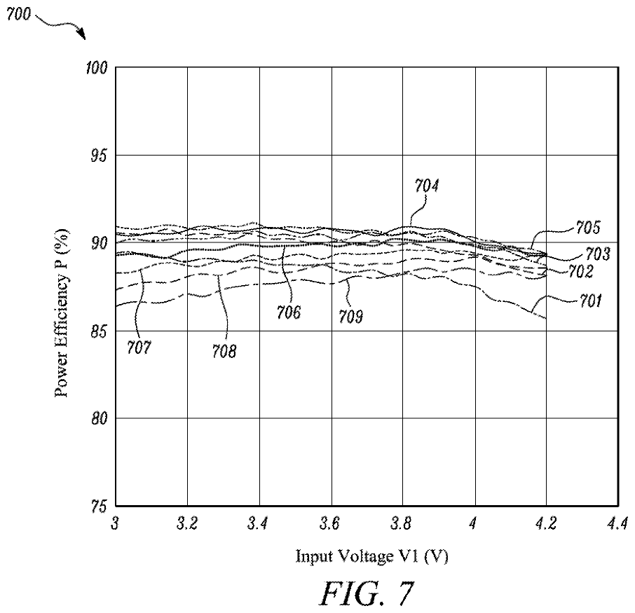

FIG. 7 illustrates a plot 700 depicting a variation of the power efficiency P of the power supply system 200 (shown in FIG. 1) with the input voltage V1 for different switching frequencies F when the total load current i2 was about 0.4 A. The input voltage V1 is depicted in Volts (V) in the abscissa and the power efficiency P of the power supply system 200 is depicted as a power efficiency percentage in the ordinate.

Referring now to FIGS. 1 and 7, the plot 700 illustrates a curve 701 depicting the variation of the power efficiency P of the power supply system 200 with the input voltage V1 for the switching frequency F of 100 kHz, a curve 702 depicting the variation of the power efficiency P of the power supply system 200 with the input voltage V1 for the switching frequency F of 150 kHz, a curve 703 depicting the variation of the power efficiency P of the power supply system 200 with the input voltage V1 for the switching frequency F of 200 kHz, a curve 704 depicting the variation of the power efficiency P of the power supply system 200 with the input voltage V1 for the switching frequency F of 250 kHz, a curve 705 depicting the variation of the power efficiency P of the power supply system 200 with the input voltage V1 for the switching frequency F of 300 kHz, a curve 706 depicting the variation of the power efficiency P of the power supply system 200 with the input voltage V1 for the switching frequency F of 350 kHz, a curve 707 depicting the variation of the power efficiency P of the power supply system 200 with the input voltage V1 for the switching frequency F of 400 kHz, a curve 708 depicting the variation of the power efficiency P of the power supply system 200 with the input voltage V1 for the switching frequency F of 450 kHz, and a curve 709 depicting the variation of the power efficiency P of the power supply system 200 with the input voltage V1 for the switching frequency F of 500 kHz.

As is apparent from the curves 701 to 709, for the total load current i2 of about 0.4 A, the optimal switching frequency F at which the power efficiency P of the power supply system 200 was optimal was about 250 kHz (depicted by the curve 704).

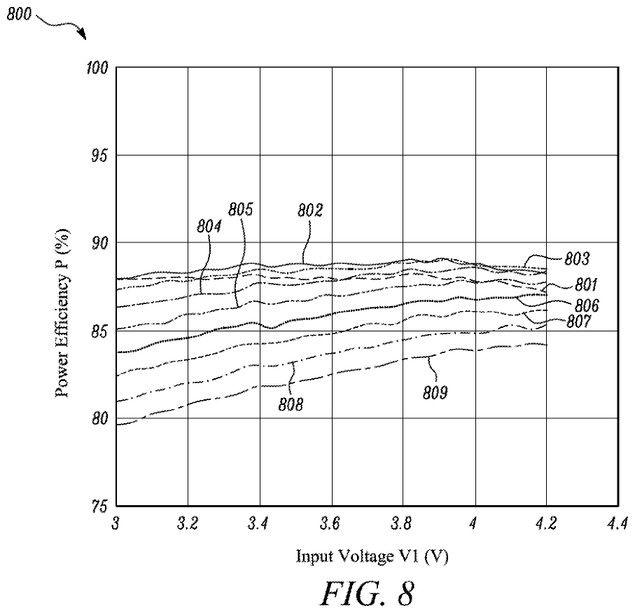

FIG. 8 illustrates a plot 800 depicting a variation of the power efficiency P of the power supply system 200 (shown in FIG. 1) with the input voltage V1 for different switching frequencies F when the total load current i2 was about 0.6 A. The input voltage V1 is depicted in Volts (V) in the abscissa and the power efficiency P of the power supply system 200 is depicted as a power efficiency percentage in the ordinate.

Referring now to FIGS. 1 and 8, the plot 800 illustrates a curve 801 depicting the variation of the power efficiency P of the power supply system 200 with the input voltage V1 for the switching frequency F of 100 kHz, a curve 802 depicting the variation of the power efficiency P of the power supply system 200 with the input voltage V1 for the switching frequency F of 150 kHz, a curve 803 depicting the variation of the power efficiency P of the power supply system 200 with the input voltage V1 for the switching frequency F of 200 kHz, a curve 804 depicting the variation of the power efficiency P of the power supply system 200 with the input voltage V1 for the switching frequency F of 250 kHz, a curve 805 depicting the variation of the power efficiency P of the power supply system 200 with the input voltage V1 for the switching frequency F of 300 kHz, a curve 806 depicting the variation of the power efficiency P of the power supply system 200 with the input voltage V1 for the switching frequency F of 350 kHz, a curve 807 depicting the variation of the power efficiency P of the power supply system 200 with the input voltage V1 for the switching frequency F of 400 kHz, a curve 808 depicting the variation of the power efficiency P of the power supply system 200 with the input voltage V1 for the switching frequency F of 450 kHz, and a curve 809 depicting the variation of the power efficiency P of the power supply system 200 with the input voltage V1 for the switching frequency F of 500 kHz.

As is apparent from the curves 801 to 809, for the total load current i2 of about 0.6 A, the optimal switching frequency F at which the power efficiency P of the power supply system 200 was optimal was about 150 kHz (depicted by the curve 802).

From the plots 600, 700, and 800, it was observed that the optimal frequency for the plurality of switches 108 may be determined depending on the total load current i2. Further, at higher switching frequencies F, the power efficiency P improved for lower total load currents i2 and at lower switching frequencies F, the power efficiency P improved for higher total load currents i2.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled to,” “stacked on” or “in contact with” another element, component, or layer, it can be directly on, directly connected to, directly coupled to, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled to,” or “directly in contact with” another element, there are no intervening elements, components, or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof Δny features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples have been described. These and other examples are within the scope of the following claims.

1. A power supply system comprising:
a transformer comprising at least one primary winding and at least one secondary winding;
a plurality of switches configured to receive an input direct current (DC) power and provide a transformer input power to the at least one primary winding based on the input DC power, wherein the input DC power is a product of an input current and an input voltage, and wherein the at least one secondary winding is configured to provide a transformer output power based on the transformer input power;
a rectifier circuit configured to receive the transformer output power and provide an output DC power to one or more external loads electrically coupled to the power supply system based on the transformer output power, wherein the output DC power is a product of a total load current and an output voltage; and
a controller communicably coupled to the plurality of switches, wherein the controller is configured to:
determine the total load current required for the one or more external loads; and
control the plurality of switches to provide a switching frequency based on the total load current required for the one or more external loads.

2. The power supply system of claim 1, wherein the controller is further configured to:
control the plurality of switches to provide the switching frequency in a first frequency range when the total load current required for the one or more external loads is greater than about 0 Ampere and less than or equal to about 0.2 Amperes;
control the plurality of switches to provide the switching frequency in a second frequency range non-overlapping with the first frequency range when the total load current required for the one or more external loads is greater than about 0.2 Amperes and less than or equal to about 0.4 Amperes; and
control the plurality of switches to provide the switching frequency in a third frequency range non-overlapping with each of the first and second frequency ranges when the total load current required for the one or more external loads is greater than about 0.4 Amperes and less than or equal to about 0.6 Amperes.

3. The power supply system of claim 2, wherein the controller is further configured to control the plurality of switches to provide the switching frequency in the first frequency range when the total load current required for the one or more external loads is greater than about 0.02 Amperes and less than or equal to about 0.2 Amperes.

4. The power supply system of claim 2, wherein the first frequency range is from greater than about 350 kilohertz (kHz) to less than or equal to about 500 kHz, the second frequency range is from greater than about 200 kHz to less than or equal to about 350 kHz, and the third frequency range is from greater than or equal to about 50 kHz to less than or equal to about 200 kHz.

5. The power supply system of claim 1, wherein the controller is further configured to:
control the plurality of switches to provide the switching frequency of about 400 kHz when the total load current required for the one or more external loads is greater than about 0 Ampere and less than or equal to about 0.2 Amperes;
control the plurality of switches to provide the switching frequency of about 250 kHz when the total load current required for the one or more external loads is greater than about 0.2 Amperes and less than or equal to about 0.4 Amperes; and
control the plurality of switches to provide the switching frequency of about 150 kHz when the total load current required for the one or more external loads is greater than about 0.4 Amperes and less than or equal to about 0.6 Amperes.

6. The power supply system of claim 1, further comprising a power source configured to provide the input DC power to the plurality of switches.

7. The power supply system of claim 6, wherein the power source is a variable voltage source.

8. The power supply system of claim 1, further comprising one or more current sensors communicably coupled to the controller, wherein the controller is further configured to receive respective signals from the one or more current sensors indicative of the input current, and wherein the controller is configured to determine the total load current as a product of the input current based on the respective signals and a transformer turn ratio of the transformer.

9. The power supply system of claim 1, further comprising one or more current sensors communicably coupled to the controller, wherein the controller is further configured to receive respective signals from the one or more current sensors indicative of respective load currents required for the one or more external loads, and wherein the controller is configured to determine the total load current as a sum of the respective load currents required for the one or more external loads based on the respective signals.

10. The power supply system of claim 1, wherein the controller is communicably coupled to the one or more external loads, wherein the controller is further configured to receive respective signals from the one or more external loads indicative of respective load currents required for the one or more external loads, and wherein the controller is further configured to determine the total load current as a sum of the respective load currents required for the one or more external loads based on the respective signals.

11. The power supply system of claim 1, wherein the controller is configured to determine a total number of the one or more external loads electrically coupled to the power supply system, and wherein the controller is configured to determine the total load current required for the one or more external loads based on the number of the one or more external loads electrically coupled to the power supply system.

12. The power supply system of claim 1, further comprising a memory communicably coupled to the controller, wherein the memory is configured to store respective one or more parameters associated with the one or more external loads, wherein the respective one or more parameters comprise respective data of load currents required for the one or more external loads, and wherein the controller is further configured to retrieve the respective data of load currents from the memory and determine the total load current as a sum of the respective load currents required for the one or more external loads based on the respective one or more parameters.

13. The power supply system of claim 1, wherein the controller controls the switching frequency, such that a power efficiency of the power supply system is greater than about 80% for the input voltage greater than or equal to about 2 Volts and less than or equal to about 5 Volts, and wherein the power efficiency is a percentage ratio of the output DC power to the input DC power.

14. An article of personal protective equipment (PPE) comprising the power supply system of claim 1.

15. A method of improving a power efficiency of a power supply system, the method comprising:
providing a transformer comprising at least one primary winding and at least one secondary winding,
receiving, by a plurality of switches, an input DC power, wherein the input DC power is a product of an input current and an input voltage;
providing, via the plurality of switches, a transformer input power to the at least one primary winding based on the input DC power;
providing, via the at least one secondary winding, a transformer output power based on the transformer input power to a rectifier circuit;
providing, via the rectifier circuit, an output DC power to one or more external loads electrically coupled to the power supply system based on the transformer output power, wherein the output DC power is a product of a total load current and an output voltage;
determining, via a controller, the total load current required for the one or more external loads; and
controlling, via the controller, the plurality of switches to provide a switching frequency based on the determined total load current required for the one or more external loads.

16. The method of claim 15, wherein controlling the plurality of switches further comprises:
controlling the plurality of switches to provide the switching frequency in a first frequency range when the total load current required for the one or more external loads is greater than about 0 Ampere and less than or equal to about 0.2 Amperes;
controlling the plurality of switches to provide the switching frequency in a second frequency range non-overlapping with the first frequency range when the total load current required for the one or more external loads is greater than about 0.2 Amperes and less than or equal to about 0.4 Amperes; and
controlling the plurality of switches to provide the switching frequency in a third frequency range non-overlapping with each of the first and second frequency ranges when the total load current required for the one or more external loads is greater than about 0.4 Amperes and less than or equal to about 0.6 Amperes.

17. The method of claim 16, wherein controlling the plurality of switches further comprises controlling the plurality of switches to provide the switching frequency in the first frequency range when the total load current required for the one or more external loads is greater than about 0.02 Amperes and less than or equal to about 0.2 Amperes.

18. The method of claim 16, wherein the first frequency range is from greater than about 350 kHz to less than or equal to about 500 kHz, the second frequency range is from greater than about 200 kHz to less than or equal to about 350 kHz, and the third frequency range is from greater than or equal to about 50 kHz to less than or equal to about 200 kHz.

19. The method of claim 15, wherein controlling the plurality of switches further comprises:
controlling the plurality of switches to provide the switching frequency of about 400 kHz when the total load current required for the one or more external loads is greater than about 0 Ampere and less than or equal to about 0.2 Amperes;
controlling the plurality of switches to provide the switching frequency of about 250 kHz when the total load current required for the one or more external loads is greater than about 0.2 Amperes and less than or equal to about 0.4 Amperes; and
controlling the plurality of switches to provide the switching frequency of about 150 kHz when the total load current required for the one or more external loads is greater than about 0.4 Amperes and less than or equal to about 0.6 Amperes.

20. The method of claim 15, wherein determining the total load current required for the one or more external loads further comprises:
providing one or more current sensors;
receiving, via the controller, respective signals from the one or more current sensors indicative of the input current; and
determining, via the controller, the total load current as a product of the input current based on the respective signals and a transformer turn ratio of the transformer.

21-26. (canceled)
